(19) United States
(12) Patent Application Publication
(10) Pub. No.: US 2005/0018129 A1
(43) Pub. Date: Jan. 27, 2005

(54) Auxiliary eyewear system with expandable bridge clip

(76) Inventor: Greg Smith, Plano, TX (US)

Correspondence Address: STORM & HEMINGWAY, L.L.P., 8117 PRESTON RD., STE. 460, DALLAS, TX, 75225, US

(21) Appl. No.: 10/767,537

(22) Filed: Jan. 29, 2004

Related U.S. Application Data
(60) Provisional application No. 60/489,553, filed on Jul. 23, 2003.

(51) Int. Cl. G02C 9/00; G02C 3/04

(52) U.S. Cl. 351/56

(57) ABSTRACT

The present invention discloses a unique and novel system for attaching auxiliary lens assemblies to primary lens assemblies without the need for magnets, and in a manner that resists disengagement in every direction. A primary lens assembly is disclosed having a primary bridge between the primary lenses. An auxiliary lens assembly is disclosed having a auxiliary bridge between the auxiliary lenses, and an expandable clip engagable with the primary bridge

### RELATED ART

This application claims priority to U.S. Provisional Patent No. 60/489,553, which was filed on Jul. 23, 2003.

### TECHNICAL FIELD OF INVENTION

The present invention relates to eyewear, and in particular, to a design for and auxiliary lens assembly and primary lens assembly combination in which the auxiliary lens assembly is adapted for secure attachment to the primary lens assembly. More specifically, the present invention discloses an auxiliary eyewear support system utilizing a novel bridge clip design for fitted support which mechanically resists disengagement in all directions.

### BACKGROUND OF THE INVENTION

It has long been desirable to have a removable auxiliary lens attached to eyeglasses. Professional baseball players have used “flip-up” auxiliary lenses for more than four decades to protect their eyes from the sun, but that allow them unrestricted vision in the event the ball were hit in their vicinity. These and other mechanically clipped on devices for holding auxiliary lenses are cumbersome and unattractive. More recently, numerous attempts have been made to magnetically attach an auxiliary lens frame to a primary lens frame.

U.S. Pat. No. 4,070,103 to Meeker discloses a primary lens frame having a slidably attachable auxiliary lens. In this device, the primary lens frame is made of magnetizable material and auxiliary lenses are individually securable to the primary lens frame by a magnetic band inserted in a groove on the inside surface of the individual auxiliary lens frame.

U.S. Pat. No. 5,416,537 to Sadler discloses a primary lens frame having a first magnetic member attached vertically to the front surface of the primary lens frame, and a second magnetic member attached in a corresponding position on the back surface on an auxiliary lens frame. The magnetic members are arranged for engagement to secure the auxiliary lens frame to the primary lens frame. This design suffers from its reliance on magnetic engagement and frequent disengagement of the auxiliary lens in the presence of the normal forces of impact and acceleration that are realized in daily activity or exercise.

U.S. Pat. No. 5,568,207 to Chao also discloses a magnetically adhered auxiliary lens frame, with the additional feature of arms extending from the side portions of the auxiliary lens frame, over magnet retaining projections and extensions of the primary lens frame. The arms engage with, and are supported on, the primary lens frame extensions to prevent disengagement of the auxiliary lens frame upon downward movement of the auxiliary lens frame relative to the primary lens frame. This design however, still requires multiple magnets in addition to reliance on planer contact between other frame elements to stabilize the relationship between the primary and auxiliary frames. The combined mechanical and magnetic engagement system is large, heavy, overtly visible, and difficult to manufacture.

U.S. Pat. No. 5,737,054 to Chao also discloses a magnetically and mechanically attached auxiliary lens frame in which the design is essentially identical to that of U.S. Pat. No. 5,568,207, except that the location of the hooking engagement and magnets is in the bridge portion of the auxiliary and primary lens frames. This design thus suffers from the same problems as those listed above.

Magnetic attachment systems such as those described above, require precision alignment of magnetic surfaces, usually on both sides of the primary and auxiliary lens frames. Besides the manufacturing challenges and costs which this presents, there are other limitations. Magnets of the type used in these devices eventually lose magnetic field strength, and will eventually be unable to support the auxiliary lens frames. The designs require large frame structures, thick enough to secure the magnets in. Magnetic materials are generally high-density materials that are heavier, and thus left comfortable to wear and carry. Current eyewear designs include thin and flexible frames, in which the mounting of magnets is more difficult and which can cause additional alignment difficulties with the magnets. Misaligned magnets exhibit a weaker magnetic attraction and a decreased life. Magnets of the type used need to be relatively strong to sufficiently secure the auxiliary frames to the primary frames. While unknown at this time, there may be reason to be concerned about the potential of unidentified health issues related to the long-term exposure to the magnetic fields present in close proximity to the human eye and face.

It can thus be seen that there is a need to develop a design for an auxiliary lens frame and primary lens frame combination in which the auxiliary lens frame is designed to securely attach to the primary lens frame without the use of magnets.

### SUMMARY OF THE INVENTION

A primary advantage of the present invention is that it provides an auxiliary lens assembly and primary lens assembly combination in which the auxiliary lens assembly is designed to securely attach to the primary lens assembly without the use of magnets. Another advantage of the present invention is provides an auxiliary lens assembly and primary lens assembly combination that is less expensive to manufacture. Another advantage of the present invention is that it increases the stability of the auxiliary lens assembly and resistance to disengagement in the presence of the normal forces of impact and acceleration that are realized in daily activity or exercise. Another advantage of the present invention is that it provides resistance to disengagement in a larger number of coordinate directions than past designs.

Another advantage of the present invention is that it increases stability of the attachment of the primary and auxiliary lens assemblies with only requiring multiple alignments between mechanical and magnetic structures. Another advantage of the present invention is that it encourages proper alignment of the auxiliary lens in relation to the primary lens upon application. Another advantage of the present invention is that the auxiliary lens assembly can be “frameless,” and does not require a lens-surrounding frame to be connectable to the primary lens assembly. Another advantage of the present invention is that it is lightweight.

Another advantage of the present invention is that the auxiliary lens assembly is dimensionally smaller, and thus easier to store than other designs. Another advantage of the present invention is that the attachment mechanism is esthetically non-obvious. Other advantages of the present invention will become apparent from the following descriptions, taken in connection with the accompanying drawings, wherein, by way of illustration and example, an embodiment of the present invention is disclosed. As referred to hereinabove, the “present invention” refers to one or more embodiments of the present invention which may or may not be claimed, and such references are not intended to limit the language of the claims, or to be used to construe the claims in a limiting manner.

In accordance with one aspect of the invention, there is provided a primary lens assembly having a pair of primary lenses. A leg portion is attached to each primary lens. A primary bridge is attached between the primary lenses. An auxiliary lens assembly has a pair of auxiliary lenses. An auxiliary bridge is attached between the auxiliary lenses. The auxiliary bridge includes an expandable clip. The clip may be expanded to allow the auxiliary bridge to engage with the primary bridge, and thus secure the auxiliary lens assembly to the primary lens assembly.

In a preferred embodiment, at least one relief is located on the primary bridge. Complimentary projections are located on the auxiliary bridge. In this embodiment, the projections are insertable into the reliefs when the auxiliary bridge is engaged with the primary bridge. The result is additional resistance to disengagement of the auxiliary lens assembly from the primary lens assembly.

In a more preferred embodiment, a radius is located on the forward end of the primary bridge, which allows smooth distribution of forces when the projection of the clip is being expanded over the primary bridge.

In a still more preferred embodiment, a relief is located on the internal end of the clip. The relief is complimentarily receivable of the radius of the primary bridge when the auxiliary bridge is engaged with the primary bridge.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a preferred embodiment of the present invention, disclosing a primary lens assembly and an auxiliary lens assembly illustrating the assemblies separate, and not attached.

FIG. 2 is an isometric view of the preferred embodiment disclosed in FIG. 1, illustrating the primary lens assembly and the auxiliary lens assembly attached.

FIG. 3 is an isometric view of another preferred embodiment, disclosing a primary lens assembly in which a frame surrounds the lenses. Also shown is an auxiliary lens assembly illustrating the assemblies separate, and not attached.

FIG. 4 is a top view of the preferred embodiment disclosed in FIG. 1, illustrating the assemblies separate, and not attached.

FIG. 5 is a top view of the preferred embodiment disclosed in FIG. 1, illustrating the primary lens assembly and the auxiliary lens assembly attached.

FIG. 6 is a front sectional view of the preferred embodiment disclosed in FIG. 1, illustrating the primary lens assembly and the auxiliary lens assembly attached.

FIG. 7 is cross-sectional view the primary bridge flange of the preferred embodiment disclosed in FIG. 1.

FIG. 8 is cross-sectional view of the auxiliary bridge clip of the preferred embodiment disclosed in FIG. 1.

FIG. 9 is cross-sectional view of the primary bridge flange of the preferred embodiment disclosed in FIG. 1.

FIG. 10 is a cross-sectional view of the auxiliary bridge clip of the preferred embodiment disclosed in FIG. 1.

FIG. 11 is a cross-sectional view of the auxiliary bridge clip, and the primary bridge flange of the preferred embodiment disclosed in FIG. 2, illustrating partial engagement of the primary and auxiliary bridges, with the auxiliary bridge clip expanded.

FIG. 12 is cross-sectional view of the primary bridge flange and the auxiliary bridge clip of the preferred embodiment disclosed in FIG. 4, illustrating full engagement of the primary and auxiliary bridges.

FIG. 13 is an isometric view of the preferred embodiment disclosed in FIG. 3, disclosing a primary lens assembly and an auxiliary lens assembly having frames around the perimeters of the lenses.

FIG. 14 is an isometric view of the preferred embodiment disclosed in FIG. 3, illustrating the primary lens assembly and the auxiliary lens assembly attached.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

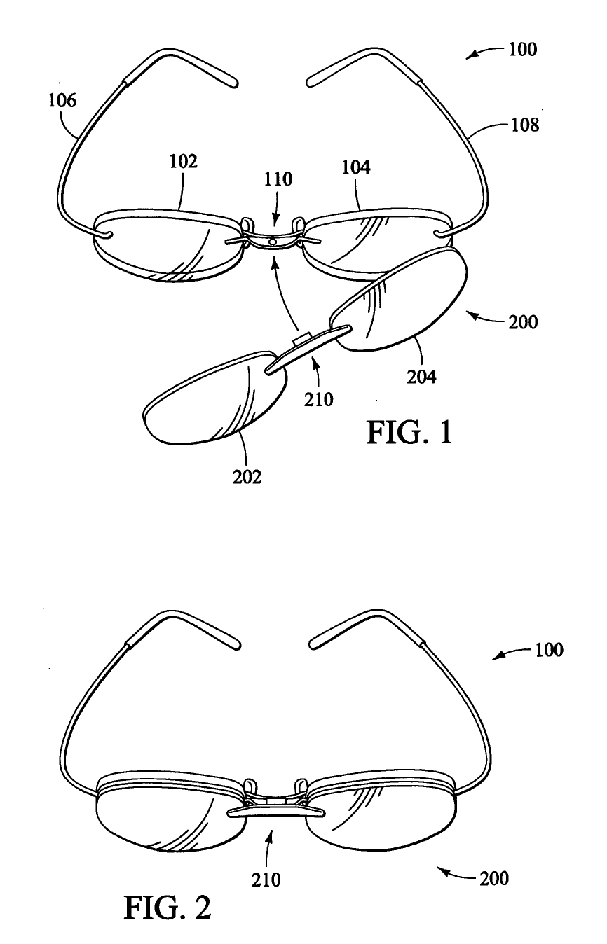

FIG. 1 is an isometric view of a preferred embodiment of the present invention. In this view, a primary lens assembly 100 and an auxiliary lens assembly 200 are illustrated separate, and not attached. Primary lens assembly 100 has a right lens 102 and a left lens 104. A right leg 106 is attached to right lens 102. A left leg 108 is attached to left lens 104. A primary bridge 110 is attached between right lens 102 and left lens 104.

Also disclosed in FIG. 1 is auxiliary lens assembly 200. Auxiliary lens assembly 200 has a right lens 202 and a left lens 204. An auxiliary bridge 210 is attached between right lens 202 and left lens 204. The preferred embodiment illustrated is of a frameless design, in which auxiliary bridge 210 attaches directly to right lens 202 and left lens 204.

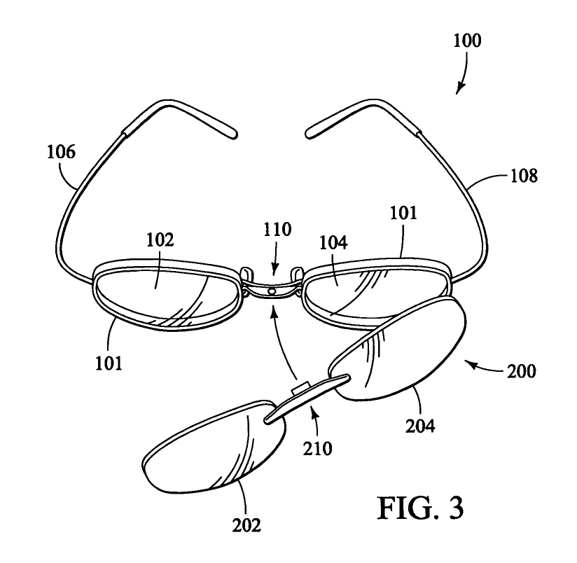

The “attached between” reference to the location of primary bridge 110 as used herein is intended to fully describe all embodiments, including by way of example, and not by limitation, primary lens assemblies in which a frame 101 (see FIG. 3) provides full or partial perimeter support for securing right lens 102 and left lens 104 in primary lens assembly 100. In this configuration, primary bridge 110 may be “attached between” that portion of frame 101 covering the interior perimeter of right lens 102 and left lens 104, and is still properly described as attached between right lens 102 and left lens 104.

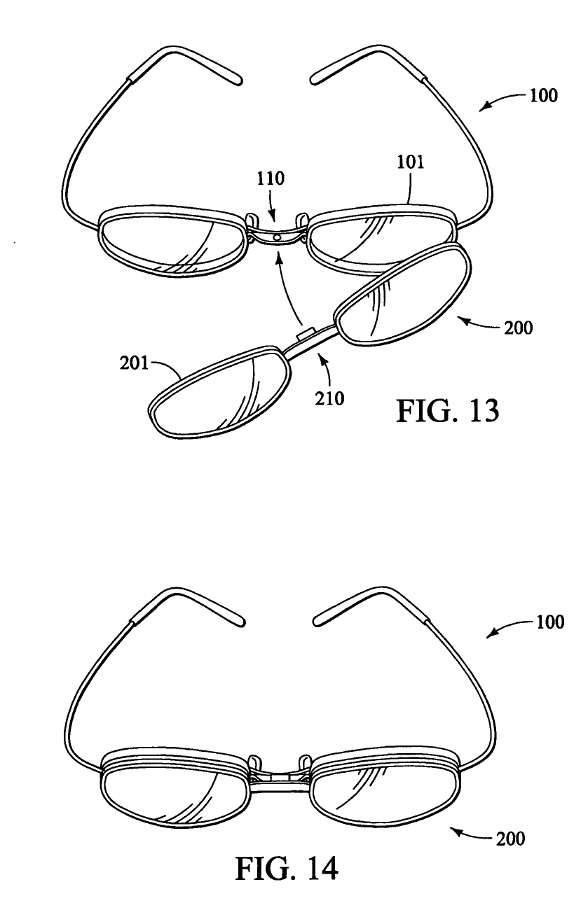

Likewise, the “attached between” reference to the location of auxiliary bridge 210 as used herein is intended to fully describe all embodiments, including by way of example, and not by limitation, auxiliary lens assemblies in which a frame 201 (see FIG. 13) provides full or partial perimeter support for securing right lens 202 and left lens 204 in auxiliary lens assembly 200. In this embodiment, auxiliary bridge 210 is “attached between” that portion of frame 201 covering the interior perimeter of right lens 202 and left lens 204 and is still properly described as attached between right lens 202 and left lens 204.

FIG. 2 is an isometric view of the preferred embodiment disclosed in FIG. 1. In this view, primary lens assembly 100 and auxiliary lens assembly 200 are illustrated separate, and not attached. Primary lens assembly 100 has a right lens 102 and a left lens 104. A right leg 106 is attached to right lens 102. A left leg 108 is attached to left lens 104. A primary bridge 110 is attached between right lens 102 and left lens 104.

FIG. 3 is an isometric view of a preferred embodiment of the present invention. In this view, primary lens assembly 100 includes a frame 101 which fully or partially surrounds right lens 102 and a left lens 104.

FIG. 4 is a top view of the preferred embodiment disclosed in FIG. 1. As seen in this view, primary bridge 110 includes a flange 112. In a preferred embodiment, flange 112 includes a relief 122 (see FIG. 7). Auxiliary bridge 210 includes an expandable clip 212 which can expand sufficiently to engage over flange 112 of primary bridge 110.

FIG. 5 is a top view of the preferred embodiment disclosed in FIG. 1, illustrating primary lens assembly 100 and the auxiliary lens assembly 200 attached.

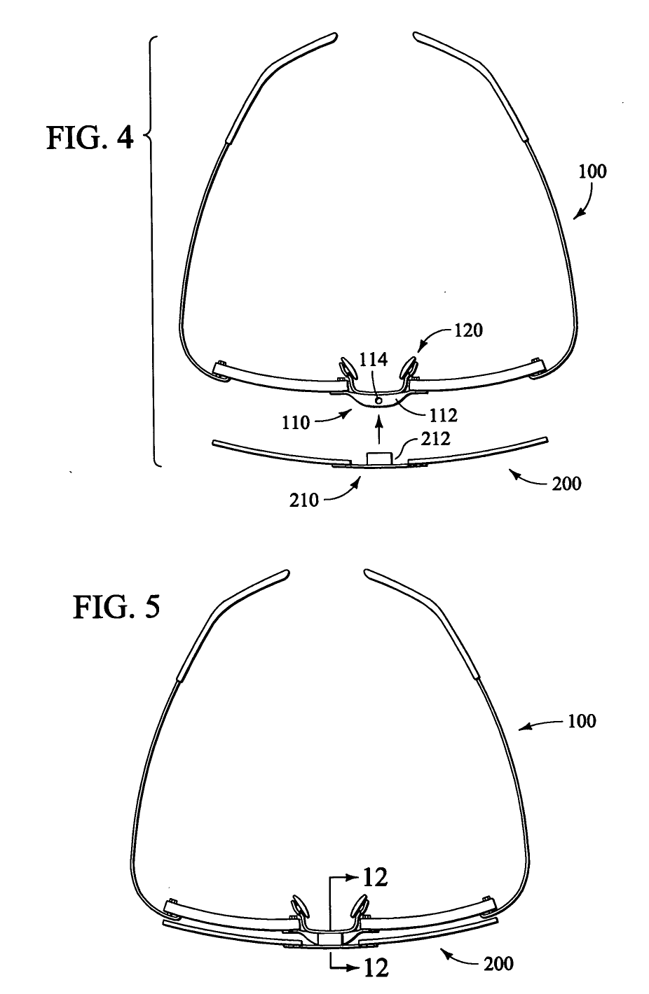

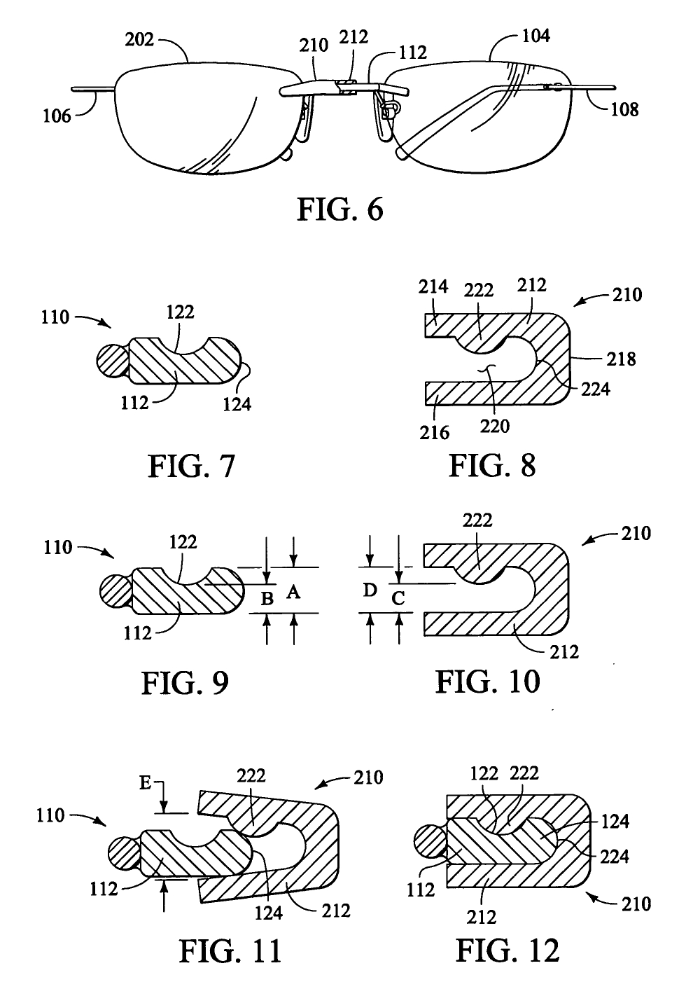

FIG. 6 is a front sectional view of the preferred embodiment of the present invention disclosed in FIG. 5, illustrating a cut-away along Section Line 12-12 of FIG. 5. In the view, the engagement of clip 212 over flange 112 is shown.

FIG. 7 is a close-up cross-sectional view of primary bridge 110 of the preferred embodiment disclosed in FIG. 1. Flange 112 of primary bridge 110 is shown in this view. In a more preferred embodiment, a relief 122 is located on flange 112. In an alternate embodiment, relief 122 is located on the bottom surface of flange 112. In a still more preferred embodiment, flange 112 has a radiused end 124.

FIG. 8 is cross-sectional view of clip 212 of auxiliary bridge 210 of the preferred embodiment disclosed in FIG. 1. Clip 212 has an upper panel 214, and an opposite lower panel 216, connected by a rear panel 218. Together, upper panel 214, lower panel 216 and rear panel 218 form a slot 220. Slot 220 is receivable of flange 112 of primary bridge 110. In a preferred embodiment, a projection 222 is located on the interior surface of upper panel 214. In an alternate embodiment, projection 222 is located on the interior surface of lower panel 216. The location of projection 222 is such that it matches the location of relief 122 (see FIG. 7) of flange 112 (see FIG. 7). In the preferred embodiment, relief 122 of flange 112 is receivable of projection 222 of clip 212 in a complementary fit. In an alternative embodiment (not shown), flange 112 has multiple reliefs 122 for complementary fit of multiple projection 222. The multiple reliefs may form a series of steps along a single surface of flange 112, or may be located on the opposing upper and lower surfaces of flange 112.

In a preferred embodiment illustrated in FIG. 8, clip 210 has an interior radius 224. In a more preferred embodiment, interior radius 224 is receivable of radiused end 124 (see FIG. 7) of flange 110 (see FIG. 7) in a complimentary fit.

FIG. 9 is cross-sectional view of primary bridge 110 as disclosed in FIG. 1. In a preferred embodiment, flange 112 has an associated dimensional thickness A. In another preferred embodiment, flange 112 has an associated dimensional relief thickness B.

FIG. 10 is cross-sectional view the auxiliary bridge 210 as disclosed in FIG. 1. In a preferred embodiment, slot 220 (see FIG. 7) of clip 212 has an associated dimensional thickness D. In another preferred embodiment, slot 220 (see FIG. 7) has a reduced thickness C beneath projection 222.

FIG. 11 is cross-sectional view primary bridge 110 and auxiliary bridge 210 as disclosed in FIG. 1, illustrating partial engagement of primary bridge 110 and auxiliary bridge 210, with clip 212 expanded. In this view, it can be seen that the interfering relationship between radiused end 124 of flange 112 and projection 222 of clip 212 forces interim expansion of slot 220 (see FIG. 7) to a dimension E.

FIG. 12 is cross-sectional view of primary bridge 110 (see FIG. 11) and auxiliary bridge 210 of the preferred embodiment disclosed in FIG. 1, illustrating full engagement between auxiliary bridge 210 and primary bridge 110 (see FIG. 1). In this preferred embodiment, flange 112 is disclosed as locatable in slot 220 in a complimentary fit of the respective cross-sectional perimeters of the flange 112 and the clip 212.

FIG. 13 is an isometric view of a preferred embodiment of the present invention. In this view, primary lens assembly 100 and an auxiliary lens assembly 200 are illustrated separate, and not attached. Primary lens assembly 100 has a frame 101 surrounding right lens 102 and left lens 104. A right leg 106 (see FIG. 1) is attached to frame 101. A left leg 108 is also attached to frame 101. Primary bridge 110 is attached between the right and left halves of frame 101.

FIG. 14 is an isometric view of the preferred embodiment disclosed in FIG. 1. In this view, primary lens assembly 100 and auxiliary lens assembly 200 are illustrated attached.

### OPERATION OF A PREFERRED EMBODIMENT

As shown in FIG. 1, the disclosed invention provides an eyewear system comprising primary lens assembly 100 having primary lenses 102 and 104. In the embodiment shown, right leg 106 is attached to right lens 102, and left leg 108 is attached to left lens 104. In this embodiment, primary bridge 110 is attached between right lens 102 and left lens 104. In the preferred embodiment, primary bridge 110 has a flange 112 (see FIG. 4). This is known as a “frameless” design.

In an alternative embodiment, shown in FIG. 3, primary lens assembly 100 includes a frame 101 which fully (or partially) surrounds primary lenses 102 and 104. In this embodiment, right leg 106 and left leg 108 are attached to frame 101. Also in this embodiment, primary bridge 110 may be attached between the right and left sides of frame 101. This is a standard “framed” design. Thus, as stated above, the present invention applies to framed or frameless designs, as well as “open-edge” designs in which frame 101 only partially surrounds the lenses 102 and 104. As such, the presence or absence of lenses 102 and 104, or 202 and 204 is seen to be irrelevant to the merits of the present invention, and such lenses may by customized for the wearer, and later installed into primary lens assembly 100 or auxiliary lens assembly 200.

Auxiliary lens assembly 200 is also disclosed in FIG. 1. Referring to FIG. 13 and FIG. 14, it is seen that the present invention applies to framed or frameless designs, as well as “open-edge” designs. A frameless auxiliary lens assembly 200 is shown in FIG. 1. Auxiliary lens assembly 200 includes auxiliary bridge 210. Auxiliary bridge 210 includes clip 212 (see FIG. 8) Clip 212 is comprised generally of upper panel 214 (see FIG. 8) and opposite lower panel 216 (see FIG. 8) joined at rear panel 218 (see FIG. 8). Together, upper panel 214, lower panel 216, and rear panel 218, form slot 220.

Attachment of auxiliary lens assembly 200 to primary lens assembly 100 is accomplished by pressing clip 212 (see FIG. 6) of auxiliary bridge 210 onto flange 112 of primary bridge 110. Clip 212 expands to allow insertion of flange 112 into slot 220, forming an engagement between clip 212 and flange 112. This allows auxiliary frame 200 to be supported on primary frame 100, without the use of hinges, magnets, or other mechanisms.

In a preferred embodiment, illustrated in FIG. 8, at least one projection 222 is located within slot 220 of clip 212. Also in this preferred embodiment, as illustrated in FIG. 7, at least one relief 122 is located on flange 112. Projection 222 is located for complementary engagement into relief 112. In an alternative embodiment (not shown), projection 222 extends beyond flange 112 for engagement therebehind.

In this preferred embodiment, the maximum expansion of clip 212 occurs at a position coincident with partial insertion of clip 212 over flange 112. This is illustrated in FIG. 11. In this illustration, dimension E represents expanded slot 220 opening, which is greater than dimension D, which represents unexpanded slot 220 opening (see FIG. 10). As illustrated in FIG. 12, when flange 112 is fully inserted into slot 220, clip 212 retracts from its maximum expansion to form an interlocking engagement with flange 112, further securing auxiliary lens assembly 200 onto primary lens assembly 100. This prevents auxiliary lens assembly 200 from falling off primary lens assembly 100 in the absence of an external force sufficient to expand clip 212 enough to allow removal of flange 112 from slot 220.

In a more preferred embodiment, projection 222 is a convex spherical segment, and relief 122 is a complementary concave spherical segment. This embodiment permits a smooth interaction between flange 112 and clip 212 while pressing auxiliary lens assembly 200 onto primary lens assembly 100, and expanding clip 212. In an alternative embodiment (not shown), projection 222 is a convex beveled portion, and relief 122 is a complementary concave beveled portion.

In a more preferred embodiment, clip 212 has an interior radius 224 (see FIG. 8). Interior radius 224 reduces potentially detrimental stress concentrations between upper panel 214 and rear panel 218, and as between lower panel 216 and rear panel 218 when clip 212 is expanded. This reduction in stress concentrations increases the life and reliability of clip 212, permitting greater expansion of clip 212, and thus greater retaining force between primary lens assembly 100 and auxiliary lens assembly 200.

In a still more preferred embodiment, flange 112 has a radiused end 124 (see FIG. 12). In this embodiment, radiused end 124 permits smoother transitional expansion of clip 212 as against projection 222. A still more preferred embodiment combines the features of radiused end 124 and projection 222 in which projection 222 is a convex spherical segment. In this combined preferred embodiment, the curved surfaces of radiused end 124 and projection 222 provide a longer engagement surface for a smooth acceleration of upper panel 214 and lower panel 216 during expansion of clip 212.

In a more preferred embodiment, interior radius 224 is receivable of radiused end 124 of flange 110 in complementary fit. As best seen in FIG. 12, radiused end 124 permits full complementary engagement of flange 112 within slot 220, and thus greater stability of auxiliary lens assembly 200 to primary lens assembly 100.

In another alternative embodiment (not shown), flange 112 has multiple reliefs 122 for complementary fit of multiple projections 222. The multiple reliefs may form a series of steps along one surface of flange 112, or may be located on the both the opposing upper and lower surfaces of flange 112.

It will be readily apparent to those skilled in the art, and the general principles defined herein may be applied to other embodiments and applications without departing from the spirit and scope of the present invention. To that end, interior radius 224 is to be construed to include a chamfered structure, and radiused end 124, is to be construed to include a chamfered end.

1. An eyewear system comprising:
a primary lens assembly comprising;
a primary bridge attached between primary lenses;
an auxiliary lens assembly comprising;
an auxiliary bridge attached between auxiliary lenses;
the auxiliary bridge having an expandable clip; and,
whereas the clip of the auxiliary bridge is expandable to engage the bridge of the primary bridge.

2. The eyewear system of claim 1, further comprising:
a leg portion attached to each primary lens.

3. The eyewear system of claim 1, further comprising:
a flange on the front of the primary bridge; and
whereas the clip is expandable onto the flange.

4. The eyewear system of claim 3, further comprising:
whereas the flange is locatable in the clip in a complimentary fit of their respective cross-sectional perimeters.

5. The eyewear system of claim 1, further comprising:
a projection located on the auxiliary bridge.

6. The eyewear system of claim 4, further comprising:
whereas the projection is a spherical segment.

7. The eyewear system of claim 3, further comprising:
a projection located on the auxiliary bridge;
a complementary relief located on the flange; and,
whereas the projection is locatable in the relief when the clip is located on the flange.

8. The eyewear system of claim 7, further comprising:
whereas the projection is a spherical segment; and,
whereas the relief form a complementary concave spherical segment.

9. The eyewear system of claim 3, further comprising:
an interior radius located inside the clip.

10. The eyewear system of claim 3, further comprising:
a radiused end located on the flange.

11. The eyewear system of claim 3, further comprising:
an interior radius located inside the clip;
a radiused end located on the flange; and,
whereas the radiused end is complementarily locatable within the interior radius when the clip is expandable onto the flange.

12. The eyewear system of claim 3, further comprising:
a projection located on the auxiliary bridge;
a radiused end located on the flange; and,
whereas the projection engages the radiused end to expand the clip when the auxiliary bridge is pressed onto the primary bridge.
